(19) United States
(12) Patent Application Publication
(10) Pub. No.: US 2023/0114592 A1
(43) Pub. Date: Apr. 13, 2023

(54) METHOD FOR TRANSFERRING SEDIMENT IN A BODY OF WATER

(71) Applicant: VOITH PATENT GMBH, Heidenheim (DE)

(72) Inventors: Emad TAGHI ZOGHI, Satteldorf (DE); Klaus KRÜGER, Huettlingen (DE)

(21) Appl. No.: 17/913,700

(22) PCT Filed: Mar. 23, 2021
(86) PCT No.: PCT/EP2021/057337

§ 371 Date: Sep. 22, 2022

(30) Foreign Application Priority Data
Mar. 27, 2020 (DE) 10 2020 108 520.6

(51) Int. Cl. E02B 3/02; F03B 17/06

(52) U.S. Cl. CPC E02B 3/023; F03B 17/06; E02F 3/9243

(57) ABSTRACT

A method for transferring sediment in a body of water, a discharge element being situated in the body of water, which is connected to a hydroelectric power station by a connecting line in such a way that water may flow through the connecting line, and a device for providing a sediment/water mixture into the connecting line, and the device including a monitor for monitoring the sediment concentration in the provided sediment/water mixture, and a controller connected to the device to control the quantity of the sediment contained in the sediment/water mixture, and the method including: taking sediment; transferring sediment to the device for providing a sediment/water mixture; introducing the sediment/water mixture into the connecting line, the controller activating the device in such a way that the sediment quantity introduced per time interval does not exceed a predefined maximally permissible quantity, the maximally permissible sediment quantity depending on the instantaneous operating mode of the hydroelectric power station.

The present invention relates to a method for transferring sediment in a body of water, the water being part of a waterway, in which a hydroelectric power station is situated. The body of water generally includes a reservoir.

### BACKGROUND

Methods for transferring sediment in a body of water are carried out in parts of bodies of water which are threatened by siltation. These are bodies of water which are dammed up in some form, or which have a runoff, which is unsuitable for sufficient removal of the accumulated amount of sediment, due to natural conditions. In particular, parts of bodies of water, at which hydroelectric power stations are situated, are often threatened by siltation. These include pumped-storage power stations including natural upper reservoirs, storage power stations and run-of-river power stations. Most sediments are introduced into the part of the body of water threatened by siltation due to natural inflows. In addition to fighting siltation, a method of this type also results in a further advantage, in that the sediment permeability of hydroelectric power stations is restored.

WO 2019/161996 A1 describes a method for transferring sediment in bodies of water, which may be reservoirs of hydroelectric power stations, such as pumped-storage power stations. Sediment is received via a suction line, using a receiving means for receiving sediment and a pressure line for transferring the received sediment from the bottom of the body of water and to transfer it to another location. In some of the specific embodiments described, the sediment is transferred into the vicinity of a discharge element or into the discharge element of the body of water itself. The discharge element may be connected to a power station unit, for example a turbine. The sediment ultimately enters a tailwater. During the transfer, the concentration of the transferred sediment is furthermore measured with the aid of a measuring device, and the concentration is set in such a way that near-natural conditions set in in the tailwater.

### SUMMARY OF THE INVENTION

The inventors have recognized that, in the method described in WO 2019/161996 A1, erosion damage (i.e., abrasive wear) to parts of a hydroelectric power station may occur, which is associated with the discharge element of the body of water.

An object of the present invention is to provide a method for transferring sediment in a body of water, the body of water being part of a waterway, in which a hydroelectric power station is situated, in which erosion damage to parts of a hydroelectric power station may be minimized, i.e., kept as low as possible.

The present invention provides a method for transferring sediment in a body of water (1), a discharge element (3) being situated in the body of water (1), which is connected to a hydroelectric power station (2) by a connecting line (6) in such a way that water may flow out of the body of water (1) through the connecting line (6) to the hydroelectric power station (2), and a device (4) for providing a sediment/water mixture being connected to the connecting line (6) in such a way that the provided sediment/water mixture may be introduced into the connecting line (6), and the device (4) including means for monitoring the sediment concentration in the provided sediment/water mixtures, and a controller (5) being connected to the device (4) in such a way that it is able to control the quantity of the sediment introduced into the connecting line (6), and the method including the following steps:

taking sediment in the body of water (1);

transferring sediment to the device (4) for providing a sediment/water mixture;

introducing the provided sediment/water mixture into the connecting line (6);

characterized in that the controller (5) activates the device (4) in such a way that the sediment quantity which is introduced into the connecting line (6) per time unit does not exceed a predefined maximally permissible quantity to minimize erosion damage to parts of the hydroelectric power station (2), the predefined maximally permissible sediment quantity depending on the instantaneous operating mode of the hydroelectric power station (2).

### BRIEF DESCRIPTION OF THE DRAWINGS

The method according to the present invention is explained below, based on the figures.

FIG. 1 shows a body of water, at which a method according to the present invention is carried out.

### DETAILED DESCRIPTION

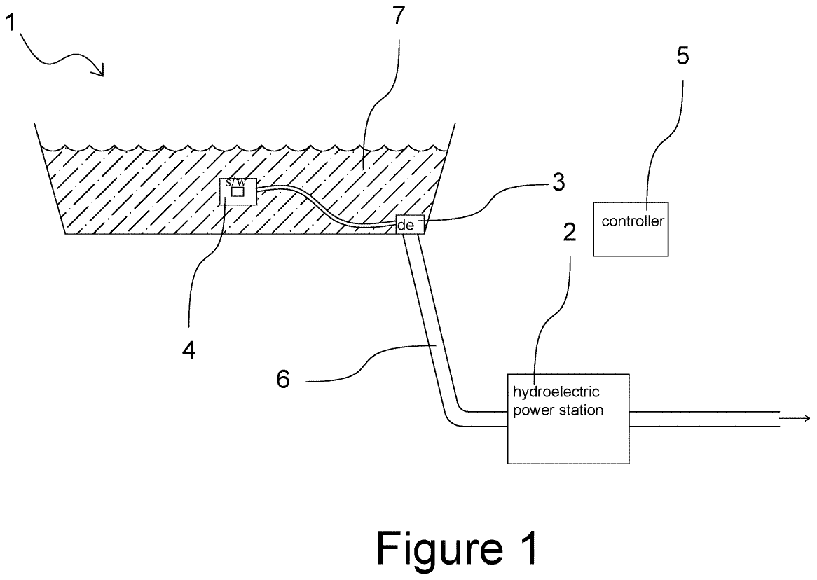

FIG. 1 shows a highly schematic representation of a body of water, at which a method according to the present invention is carried out. The body of water is identified by 1. The body of water generally includes a reservoir, which is identified by 7. A reservoir is understood to be that part of the body of water which is dammed or backed up in some form. It may thus also simply be a section of a body of flowing water, which is situated upstream from a hydroelectric power station. A discharge element, which is identified by 3, is situated in the body of water. Discharge element 3 may be designed in different ways, e.g., as a discharge in the vicinity of the bottom of the body of water, as an opening in a dam wall, as an inlet of an arbitrary design for a hydroelectric power station (e.g., as an intake screen). Discharge element 3 is connected to a hydroelectric power station, which is identified by 2, with the aid of a connecting line, which is identified by 6, in such a way that water may flow out of reservoir 7 through connecting line 6 to the hydroelectric power station. The water ultimately passes through the hydroelectric power station into a tailwater, which is not illustrated in FIG. 1. The arrow indicates the direction toward the tailwater. If hydroelectric power station 2 is a pumped-storage power station, the water may also naturally flow in the opposite direction during pumping, i.e., from the tailwater to reservoir 7. However, this flow direction is immaterial to the method according to the present invention. Connecting line 6 is generally the so-called penstock of the hydroelectric power station. However, it may also be a channel or another waterway.

FIG. 1 also shows a device for providing a sediment/water mixture, which is identified by 4. Device 4 is connected to connecting line 6 between reservoir 7 and hydroelectric power station 2 in such a way that the sediment/water mixture provided by device 4 may be introduced into connecting line 6 and may thus be discharged through hydroelectric power station 2 into the tailwater by the water flow in connecting line 6. The connection between device 4 and connecting line 6 may take place via discharge element 3, as illustrated in FIG. 1, or in another manner. According to the method according to the present invention, a deposit of sediment in reservoir 7 initially takes place. The deposited sediment is then transferred to device 4 to be ultimately introduced into connecting line 6 in the form of the aforementioned sediment/water mixture provided by device 4. In this way, a sediment transfer occurs within body of water 1, i.e., from reservoir 7 to the tailwater through hydroelectric power station 2.

Device 4 for providing a sediment/water mixture is situated somewhere in, at or in the vicinity of reservoir 7. Device 4 for providing a sediment/water mixture may be, for example, a device movable on body of water 1, as described in WO 2019/161996 A1. However, device 4 may just as well be situated on the bottom of the body of water, on the shore of reservoir 7 or at a structure in body of water 1. It is also conceivable that device 4 is situated in discharge element 3 itself or in or at connecting line 6 between discharge element 3 and hydroelectric power station 2. In any event, the sediment/water mixture provided by device 4 is introduced into connecting line 6. This may take place, for example, through a line, which extends from device 4 to discharge element 3, into which this line opens, as illustrated in FIG. 1.

The sediment/water mixture provided by device 4 is made up of sediment and water, which is collected or removed from reservoir 7. The collection or removal may then take place as described in WO 2019/161996 A1, the sediment/water mixture being generated directly during the collection or removal. Device 4 includes the means described in the aforementioned publication. Sediment and water may just as well also be each removed separately. For example, in that sediment is removed from reservoir 7 by a floating excavator, e.g., a shovel excavator or a submarine, and supplied to device 4, for example with the aid of a further floating device. The water for the mixture may be, for example, easily pumped out of body of water 1. Device 4 then generates the sediment/water mixture by mixing the individual components, the device in this case having to include suitable means for this purpose. For example, this may include a container for storing sediment, into which the floating device periodically dumps sediment.

In any event, device 4 includes means for monitoring the sediment concentration in the provided sediment/water mixture. The monitoring of the sediment concentration may take place via measuring means, which may determine the concentration. However, the monitoring may also take place in that the quantity of sediment and the water quantity are measured or monitored, which are used to provide the sediment/water mixture.

FIG. 1 furthermore shows a controller, which is identified by 5. Controller 5 is connected to device 4 for providing a sediment/water mixture in such a way that it may control the quantity of the sediment contained in the provided sediment/water mixture. The quantity of the sediment/water mixture introduced into connecting line 6 may be controlled, since, if the concentration of the sediment is known, the quantity of the sediment may also be controlled thereby. The connection of controller 5 to device 4 may also take place wirelessly. Moreover, controller 5 may also be connected in such a way that controller 5 and device 4 form one unit. Controller 5 is furthermore connected to hydroelectric power station 2 in such a way that controller 5 may use data relating to the instantaneous operating mode of hydroelectric power station 2 for controlling device 4. The connection with hydroelectric power station 2 may also take place wirelessly. Moreover, controller 5 may also be part of hydroelectric power station 2. In this case, controller 5 may also be integrated into the controller, which regulates the operation of hydroelectric power station 2.

The inventors have recognized that the erosion effect of sediment, which is admixed with the works water of a hydroelectric power station, is dependent on the operating mode of the hydroelectric power station. It is therefore advantageous if controller 5 activates device 4 in such a way that the sediment quantity introduced into connecting line 6 per time interval does not exceed a predefined maximally permissible quantity to minimize erosion damage to parts of the hydroelectric power station. The valid maximally permissible introduced sediment quantity in each case depends on the instantaneous operating mode of hydroelectric power station 2. This makes it possible to achieve the fact that erosion damage to hydroelectric power station 2 is minimized, on the one hand, and as much sediment as possible may be discharged within a given period of time, on the other hand.

The phrase, “the maximally permissible sediment quantity depends on the instantaneous operating mode of the hydroelectric power station” is to be understood in that at least one operating mode of the hydroelectric power station exists, in which the maximally permissible sediment quantity which may be introduced into the connecting line when the hydroelectric power station is in this operating mode differs from a maximum sediment quantity which may be introduced into the connecting line when the hydroelectric power station is in another operating mode. The aforementioned difference in the maximally permissible sediment quantity results to the exclusion of other influencing factors (cf. below), i.e., the latter are taken into account only as parameters having the same values when establishing the particular maximum sediment quantities. Specifically, therefore, a first operating mode B1 exists, which has an associated maximum sediment quantity max_S1, as well as a second operating mode B2, which has an associated maximum sediment quantity max_S2, B1≠B2 and max_S1≠max_S2, and all other possible influencing variables being regarded as constant. Similar definitions apply to the additional dependencies specified in the subclaims.

Each conceivable state of the hydroelectric power station, in which water flows through the hydroelectric power station, is to be understood as the operating mode of the hydroelectric power station, e.g., operation under nominal load, overload or minimal load. The operating mode of the hydroelectric power station is generally controlled via steplessly variable regulating elements, such as via a control apparatus or a nozzle, such as in Pelton stations, i.e., the operating mode is a continuously adjustable variable in hydroelectric power stations including steplessly variable regulating elements.

The predefined maximally permissible sediment quantity values may be ascertained in different ways. For example, the particular extent of erosion damage, which was caused by a certain quantity of sediment in the works water during the different operating modes of the hydroelectric power station, may be calculated with the aid of CFD (computational fluid dynamics) and other mathematical methods. The erosion damage is generally inhomogeneously distributed, i.e., there are certain components or zones on certain components, which suffer particularly high erosion damage, depending on the operating mode. The properties of the particular components are, of course, taken into account, in particular the resistance thereof to abrasive wear, which may be increased, for example, by a corresponding material selection or by a suitable coating. The establishment of the particular maximum values may include observations, which include the cost of the particular damaged components or the effort required to replace or repair the components. Alternatively, the maximally permissible sediment quantities in the works water may also be determined by experiment, for example, in a model trial or at a pilot station. In any case, the particular extent of erosion damage to parts of hydroelectric power station 2 with the relevant sediment quantity and the relevant operating mode is determined ahead of time for the purpose of ascertaining the predefined maximally permissible sediment quantity.

The method according to the present invention may be further improved if the properties of the sediment contained in each case in the sediment/water mixture are also taken into account when introducing the sediment into the connecting line. In other words, the maximally permissible sediment quantity is then additionally dependent on the properties of the instantaneously introduced sediment. This may take place in many different ways. In some cases, the method may be satisfactorily improved in that the properties of the sediment typically present in the particular body of water are taken into account. This is sufficient, in particular, if the relevant body of water has a homogeneous make-up, and no great variations set in over the course of the seasons. If the body of water has a high inhomogeneity, it is then possible to determine, for example, the area of the body of water where the sediment originates, which was just introduced into connecting line 6. If the seasons play a large role in the relevant body of water, they may be taken into account in that the maximally permissible introduced sediment quantities vary depending on the season. The method according to the present invention may generally be improved in that the quantity and/or properties of sediment naturally occurring in the works water in each case is/are taken into account, i.e., the sediment already present in the water flowing into discharge element 3 before sediment is introduced into connecting line 6 by device 4. The quantity and properties of the total sediment in the works water are understandably responsible for the erosion, regardless of whether the sediment is naturally occurring in the works water or whether the sediment was introduced into connecting line 6 by device 4. This influence may also fluctuate greatly from season to season.

In the case of the properties of the sediment, the grain size, as well as the chemical and physical properties (e.g., the hardness or roughness), of the sediment have an influence on the erosion effect. The corresponding variables may be measured with the aid of suitable measuring means of unit 4, or, as indicated above, be determined in another way (e.g., via the location of the sediment removal in the body of water) and taken into account when introduced into connecting line 6. In other words, the maximally permissible sediment quantities may also depend on these variables.

The method according to the present invention may also be improved in that certain characteristics of the sediment introduced into connecting line 6 are actively established depending on the instantaneous operating state of hydroelectric power station 2. For example, the sediment removed from reservoir 7 may be divided into multiple groups with regard to a particular property and separated in this regard prior to being introduced into connecting line 6. For example, the sediment may be divided into multiple groups and separated with respect to grain size, so that sediment having grain sizes in a first grain size range is stored in a first container, and sediment having a grain size in a second grain size range is stored in a second container, etc. Depending on the operating mode of hydroelectric power station 2, a first maximum quantity of sediment is then introduced into connecting line 6 from the first container, and a second maximum quantity of sediment is introduced thereinto from the second container, etc., per time unit, all values of the aforementioned maximum quantities being able to be dependent on the particular operating mode. In other words, it may be said that the maximally permissible sediment quantity which may be introduced into connecting line 6 is dependent on the group from which the sediment is taken.

The separation regarding the grain size may take place with the aid of a suitable sieve.

It should be noted that, in certain operating modes, it may also be possible that no sediment at all or no sediment having a certain property may be introduced into connecting line 6, i.e., the corresponding maximum values are zero.

The method according to the present invention permits a minimizing of erosion damage, which is caused to parts of a hydroelectric power station by the sediments in the works water. As an additional advantage, a calculation of the induced erosion damage is made possible in that the introduced sediment quantity is monitored. As a result, necessary repair and maintenance work may be predicted and planned, and the downtimes of the hydroelectric power station may thus be minimized.

### LIST OF REFERENCE NUMERALS

1 body of water
2 hydroelectric power station
3 discharge element
4 device for providing a sediment/water mixture
5 controller
6 connecting line
7 reservoir

1-12. (canceled)

13. A method for transferring sediment in a body of water, a discharge element being situated in the body of water and connected to a hydroelectric power station by a connecting line so that water is flowable out of the body of water through the connecting line to the hydroelectric power station, and a device for providing a sediment/water mixture being connected to the connecting line in such a way that the provided sediment/water mixture is introducable into the connecting line, and the device including a monitor for monitoring the sediment concentration in the provided sediment/water mixture, and a controller being connected to the device and capable of controlling a quantity of the sediment introduced into the connecting line, the method including the following steps:
taking sediment in the body of water;
transferring the sediment to the device for providing a sediment/water mixture;
introducing the provided sediment/water mixture into the connecting line; and
activating the device via the controller in such a way that the sediment quantity introduced into the connecting line per time unit does not exceed a predefined maximally permissible quantity so as to minimize erosion damage to parts of the hydroelectric power station, the predefined maximally permissible sediment quantity depending on an instantaneous operating mode of the hydroelectric power station.

14. The method as recited in claim 14 wherein the predefined maximally permissible sediment quantity is dependent on a property of the sediment instantaneously introduced into the connecting line.

15. The method as recited in claim 14 wherein the predefined maximally permissible sediment quantity is dependent on a season.

16. The method as recited in claim 14 wherein the predefined maximally permissible sediment quantity is depending on an area of the body of water where the sediment instantaneously introduced into the connecting line originates.

17. The method as recited in claim 14 wherein the predefined maximally permissible sediment quantity is dependent on a quantity or properties of the sediment naturally occurring in the water flowing into the discharge element.

18. The method as recited in claim 15 wherein the property of the sediment is a grain size of the sediment.

19. The method as recited in claim 15 wherein the property of the sediment is a hardness of the sediment.

20. The method as recited in claim 14 wherein characteristics of the sediment introduced into the connecting line are actively established depending on the instantaneous operating state of the hydroelectric power station.

21. The method as recited in claim 20 wherein the sediment taken from the body of water is divided into multiple groups with regard to a particular property and separated as a function of the particular property prior to being introduced into the connecting line.

22. The method as recited in claim 21 wherein groups of the multiple groups relating to a grain size are divided up so that groups of different grain sizes are created.

23. The method as recited in claim 14 wherein the predefined maximally permissible sediment quantity is dependent on the group of the multiple groups.

24. The method as recited in claim 14 further comprising assessing erosion damage to parts of the hydroelectric power station by the sediments introduced into the connecting line.
